(19) United States
(12) Patent Application Publication
(10) Pub. No.: US 2026/0305545 A1
(43) Pub. Date: Oct. 8, 2026

(54) Felling Wedge and Method for Operating a Felling Wedge

(71) Applicant: Andreas Stihl AG & Co. KG, Waiblingen (DE)

(72) Inventors: Fabian Friebe, Waiblingen (DE); Christopher Tost, Auenwald (DE); Claus Naegele, Stuttgart (DE); Dimitrios Galagas, Backnang (DE)

(73) Assignee: Andreas Stihl AG & Co. KG, Waiblingen (DE)

(21) Appl. No.: 19/635,990

(22) Filed: Apr. 1, 2026

(30) Foreign Application Priority Data
Apr. 7, 2025 (DE) 102025113597.5

(51) Int. Cl. A01G 23/099

(52) U.S. Cl. CPC A01G 23/099

(57) ABSTRACT

A felling wedge includes a base body (10), at least one engagement mechanism (11) configured to engage a tree to be felled and to fix the base body (10) relative to the tree, a pressure wedge body (20) movable relative to the base body (10), and a drive unit (40) configured to move the pressure wedge body (20) relative to the base body (10). The felling wedge (1) includes a lubricant tank (60) fixed relative to the base body (10).

Lubricant (61) is conveyable from the lubricant tank (60) to the pressure wedge body (20).

### CROSS-REFERENCE TO RELATED APPLICATION

This application claims the benefit of German Patent Application DE 102025113597.5, filed on Apr. 7, 2025, the entire contents of which is incorporated by reference.

### TECHNICAL FIELD

The disclosure relates to a felling wedge and a method for operating a felling wedge.

### BACKGROUND

A felling wedge is used when felling a tree. Typically, here a wedge-shaped felling notch is first cut with a chainsaw on the side of the tree where it will fall. On the opposite side of the tree, a pocket, in particular wedge-shaped, is then cut for the felling wedge, typically spaced further from the ground than the felling notch. The felling wedge is then inserted into the pocket. The felling wedge comprises a base body and an engagement mechanism for engaging in the tree to be felled, in particular in the pocket which has been cut into the tree by the chainsaw. Using the engagement mechanism, the base body can be fixed relative to the tree, in particular to the pocket. The felling wedge includes a pressure wedge body that is movable relative to the base body. A drive unit is provided for moving the pressure wedge body relative to the base body. To fell the tree, the pressure wedge body is driven into the tree, in particular into the pocket, by means of the drive unit, while the base body is fixed in the pocket by means of the engagement mechanism. Here, the pressure wedge body advances in the direction in which the tree is to fall. The pressure wedge body widens the pocket, such that the tree is pushed in the desired direction and finally falls.

For effective use of the felling wedge and for effective felling of the tree, lubrication of the felling wedge, in particular the drive unit and/or the pressure wedge body, is imperative. A so-called lubricating nipple is provided in the prior art for lubricating the felling wedge on the felling wedge. Grease can be introduced into the felling wedge from a separately carried grease container via the lubricating nipple. This is typically intended for lubricating the drive unit. The pressure wedge body can be greased by spraying or applying grease. This process is time-consuming and cumbersome. Usually, greasing the felling wedge is only carried out once a day in the equipment depot and not on-site in the forest. The efficiency of the felling wedge decreases with each tree felled using the felling wedge if greasing is not carried out again in between. A poorly greased felling wedge wears out more quickly.

### SUMMARY

An object of the present disclosure is to improve a known felling wedge in such a way that simple and quick lubrication of the felling wedge is possible. This object is solved by a felling wedge as disclosed herein.

A further object of the disclosure is to improve a known method for operating a felling wedge in such a way that simple and quick greasing of the felling wedge is possible. This object is solved by a method as disclosed herein.

With the felling wedge, it is provided that the felling wedge comprises a lubricant tank. The lubricant tank is fixed to the base body. In particular, the lubricant tank is an integral part of the felling wedge. In particular, the lubricant tank is allocated to the base body, such that the lubricant tank, together with the base body, is movable relative to the pressure wedge body. In particular, the lubricant tank is fixed on the base body. The felling wedge is designed in such a way that lubricant can be conveyed from the lubricant tank to the pressure wedge body. Because the lubricant tank of the felling wedge is fixed to the base body, no separate lubricant container needs to be carried. The lubricant tank is integrated into the felling wedge and is always automatically carried along. This enables simple and quick lubrication of the felling wedge with lubricant from the lubricant tank. Because the lubricant can be conveyed from the lubricant tank to the pressure wedge body, the felling wedge can be lubricated, in particular greased, easily and quickly by means of the lubricant from the lubricant tank. In doing so, lubrication of the drive unit and/or the pressure wedge body is possible, in particular.

In particular, the lubricant can be conveyed, at least indirectly, from the lubricant tank to the pressure wedge body via the drive unit. This allows the drive unit to be used simply in order to convey lubricant from the lubricant tank to the pressure wedge body. No separate conveying device is required. However, it can also be provided that the lubricant can be conveyed to the pressure wedge body by means of a conveying device formed separately from the drive unit. In particular, such a conveying device comprises a conveying pump and a motor to drive the conveying pump. However, it can also be provided that the conveying device comprises only a manually operable conveying pump. Because the drive unit is used, at least indirectly, to convey the lubricant to the pressure wedge body, a particularly simple design of the felling wedge emerges. The felling wedge is easy to manufacture and therefore requires less installation space.

In particular, the drive unit comprises a motor. In particular, the pressure wedge body can be moved relative to the base body by means of the motor. In particular, the driving force of the motor is used, at least indirectly, to convey lubricant from the lubricant tank to the pressure wedge body. However, it can also be provided that the drive unit is manually operated by the user.

In a particular development, it is provided that the felling wedge is designed in such a way that conveying lubricant from the lubricant tank to the pressure wedge body is carried out depending on a parameter or a lubricant signal generated by the user. In particular, the user can trigger lubrication of the felling wedge by means of lubricant from the lubricant tank by generating the lubricant signal. In particular, the parameter that determines the supply of lubricant from the lubricant tank to the pressure wedge body is a threshold value. When this threshold value is exceeded, conveying lubricant is permitted. In particular, lubricant is conveyed when the threshold value is exceeded.

In particular, the parameter is based on the number of forward and/or backward movements of the pressure wedge body relative to the base body. Alternatively or additionally, the parameter is based on the number of engagements of the felling wedge, in particular forward and/or backward movements of the pressure wedge body under load. In particular, the felling wedge comprises a control unit. In particular, the number of forward and/or backward movements and/or the number of engagements of the felling wedge under load is recorded in the control unit. In particular, the control unit is supplied with information about the motor current flowing through the motor to drive the drive unit. From the magnitude of the motor current, it can be concluded as to whether the felling wedge has been used under load, in particular whether the pressure wedge body has been moved relative to the base body under load. In particular, the felling wedge comprises a current measuring device for measuring the motor current.

In particular, the felling wedge is designed in such a way that the felling wedge can be put into a conveying stop mode by a feed stop signal generated by the user. In the conveying stop mode, conveying lubricant from the lubricant tank to the pressure wedge body is prevented or is not triggered. Thus, provided the felling wedge is sufficiently supplied with lubricant, the user can prevent further conveying of lubricant from the lubricant tank to the pressure wedge body by generating the feed stop signal.

In particular, the felling wedge is designed in such a way that lubricant is conveyed from the lubricant tank to the pressure wedge body with each complete retraction of the pressure wedge body against the base body. In particular, a corresponding mechanism is provided for this purpose. Because lubricant is conveyed from the lubricant tank to the pressure wedge body with each complete retraction of the pressure wedge body against the base body, the relative movement between the pressure wedge body and the base body, caused by the drive unit, can be easily used to convey lubricant from the lubricant tank to the pressure wedge body. No separate conveying device is required for this.

In particular, the felling wedge comprises two wedge jaws. Each of the wedge jaws is provided for arranging between the tree and the pressure wedge body. In particular, the pressure wedge body is arranged between the two opposing wedge jaws. In particular, the two wedge jaws are fixed to the base body. In particular, the pressure wedge body is movable relative to the two wedge jaws. In particular, the two wedge jaws move together with the base body relative to the pressure wedge body. In particular, the two wedge jaws can be forced apart by the pressure wedge body, in particular by moving the pressure wedge body away from the base body. In particular, the two wedge jaws each contact the pressure wedge body in a contact region. In particular, the lubricant is provided at least also for lubricating the contact region. In particular, the lubricant is provided at least also for lubricating the drive unit, in particular for lubricating a spindle of the drive unit. In particular, at least one engagement mechanism is formed on the wedge jaws.

In particular, the pressure wedge body has at least one channel. In particular, the at least one channel serves to guide lubricant. In particular, the at least one channel is also referred to as a hydraulic line. In particular, lubricant can be conveyed through the at least one channel from the lubricant tank to the contact region. Alternatively or additionally, it can be provided that lubricant can be conveyed through the at least one channel from the lubricant tank to the drive unit, in particular to a spindle of the drive unit. Lubrication, in particular greasing, of the felling wedge can be carried out easily through the at least one channel. The lubrication can be carried out by lubricant being conveyed through the at least one channel from the lubricant tank, which is fixed to the base body, to the contact region and/or the drive unit, in particular the spindle of the drive unit.

In particular, the pressure wedge body has a transfer point. Through this transfer point, lubricant can enter the at least one channel of the pressure wedge body from the lubricant tank, which is fixed to the base body. In particular, the felling wedge is designed in such a way that lubricant can be conveyed from the lubricant tank due to a movement of the pressure wedge body and the base body towards each other, caused by the drive unit.

In particular, the lubricant tank has an outlet opening. A valve device is arranged at the outlet opening. The valve device can be opened, in particular, by actuation with the pressure wedge body, in particular with the transfer point of the pressure wedge body. In particular, the pressure wedge body, in particular the transfer point of the pressure wedge body, presses towards the valve device during the movement of the pressure wedge body and the base body towards each other in such a way that the valve device is opened. Thus, the relative movement of the base body and the pressure wedge body caused by the drive unit is used in a simple manner in order to cause the conveying of lubricant from the lubricant tank to the pressure wedge body.

In particular, the valve device closes automatically after the actuation has ceased. In particular, the valve device closes automatically when pressure is no longer exerted on it by means of the pressure wedge body, in particular the transfer point of the pressure wedge body.

In a particular development, the valve device is designed in such a way that, during a single actuation process, only a defined volume of lubricant can be conveyed through the valve device from the lubricant tank to the pressure wedge body. During the pressing of the valve device through the pressure wedge body, in particular through the transfer point of the pressure wedge body, a precisely set volume of lubricant is conveyed into the pressure wedge body. In this way, exactly the right amount of lubricant can be conveyed for lubricating the felling wedge. The defined volume of lubricant can thus be selected in such a way that it is sufficient for a desired number of forward and/or reverse movements of the pressure wedge body relative to the base body, in particular under load. This prevents lubricant being wasted and ensures the felling wedge is lubricated to the correct degree. Wear of the felling wedge is thereby minimised. In particular, the precisely defined volume is geometrically set by the volume of a compression chamber, which is sealed off from the surrounding lubricant when the valve device is actuated.

In a particular development, it is provided that the felling wedge comprises a distance detector. In particular, the felling wedge is designed in such a way that, in the conveying stop mode of the felling wedge, at least a minimum distance is maintained between the pressure wedge body and the base body. In particular, the valve device is only actuated by the pressure wedge body, in particular by the transfer point of the at least one channel of the pressure wedge body, when the minimum distance between the pressure wedge body and the base body is not met. By the minimum distance between the pressure wedge body and the base body being maintained in the conveying stop mode, it is prevented that lubricant is conveyed from the lubricant tank to the pressure wedge body. In particular, it is prevented that the valve device is opened. This is because actuation of the valve device by the pressure wedge body is prevented. In particular, the minimum distance is the smallest distance between the base body and the pressure wedge body at which the valve device is not actuated in such a way that it is opened.

According to the method for operating a felling wedge, the felling wedge comprises a lubricant tank that is fixed to the base body. Lubricant is conveyed from the lubricant tank to the pressure wedge body. This is associated with the advantages described for the felling wedge.

In particular, the lubricant is conveyed, at least indirectly, from the lubricant tank to the pressure wedge body via the drive unit. This is also associated with the advantages described above in relation to the corresponding features of the felling wedge.

The method can be extended by the optional features of the felling wedge listed above and is associated with the advantages described therein.

### BRIEF DESCRIPTION OF THE DRAWINGS

Exemplary embodiments of the invention are explained below by means of the drawings. Here are shown in:

FIG. 1: a perspective depiction of a felling wedge with a lubricant tank,

FIG. 2: a side view of the felling wedge from FIG. 1 with the pressure wedge body fully retracted,

FIG. 3: the side view from FIG. 2 with the pressure wedge body fully extended,

FIG. 4: a perspective depiction of the pressure wedge body of the felling wedge from FIGS. 1 to 3,

FIG. 5: a perspective sectional depiction of a vertical longitudinal section through the pressure wedge body from FIG. 4,

FIG. 6: a perspective sectional depiction of a horizontal longitudinal section through the pressure wedge body from FIG. 4,

FIG. 7: a perspective depiction of the assembly comprising the pressure wedge body from FIG. 4, wedge jaws of the felling wedge and the lubricant tank,

FIG. 8: a top view of a vertical longitudinal section through the entire felling wedge, wherein the pressure wedge body is extended to such an extent that a valve device arranged at an outlet opening of the lubricant tank is not contacted by the pressure wedge body and is not actuated by the pressure wedge body,

FIG. 9: the top view of the sectional depiction from FIG. 8, wherein the pressure wedge body is approached to the base body or the valve device in such a way that it just contacts the valve device without actuating it,

FIG. 10: the top view of the sectional depiction from FIGS. 8 and 9, wherein the pressure wedge body is approached to the base body in such a way that it actuates the valve device,

FIG. 11: a schematic, perspective depiction of the pressure wedge body from FIG. 4, wherein the channels for the lubricant and the receiver for a spindle of the drive unit, which are not actually visible, are depicted with dashed lines,

FIG. 12: a perspective depiction of the assembly comprising the pressure wedge body and the base body, wherein a side wall of the felling wedge is removed to reveal a distance detector for detecting the distance between the pressure wedge body and the base body,

FIG. 13: a detail from FIG. 12,

FIG. 14: a sectional depiction of a vertical longitudinal section through the valve device and the pressure wedge body of the felling wedge, wherein the pressure wedge body is approached to the base body in such a way that it just contacts the valve device without actuating it.

FIG. 15: the depiction from FIG. 14, wherein the pressure wedge body is spaced apart from the base body and the valve device is neither contacted nor actuated,

FIG. 16: a sectional depiction of a horizontal longitudinal section through the assembly comprising the pressure wedge body and the base body,

FIG. 17: the detail labelled with XVII in FIG. 16 which shows a magnetic ring with magnets for detecting the number of revolutions by means of a Hall sensor,

FIG. 18: a perspective depiction of the magnetic ring from FIGS. 16 and 17,

FIG. 19: an exploded depiction of the lubricant tank, the valve device and the transfer point of the pressure wedge body,

FIG. 20: a schematic depiction of a felling wedge according to a first alternative design, in which a conveying pump driven by the drive unit conveys lubricant from a lubricant tank that is fixed to the base body,

FIG. 21: a schematic depiction of a felling wedge according to a second alternative design, in which a conveying device formed separately from the drive unit conveys lubricant from a lubricant tank formed to be fixed to the base body into the pressure wedge body, wherein the motor of the conveying device is formed separately from the motor of the drive unit,

FIG. 22: a schematic depiction of a felling wedge according to a third alternative design, in which lubricant can be conveyed from a lubricant tank fixed to the base body by means of a manual conveying pump,

FIG. 23: a detail from FIG. 22, which shows a spindle valve which, in the fully retracted state of the pressure wedge, closes an opening of a channel in the longitudinal end of the spindle and

FIG. 24: a depiction analogous to FIG. 23, wherein the pressure wedge is extended so far relative to the base body, such that the opening in the longitudinal end of the spindle can no longer be closed by the spindle valve.

### DETAILED DESCRIPTION

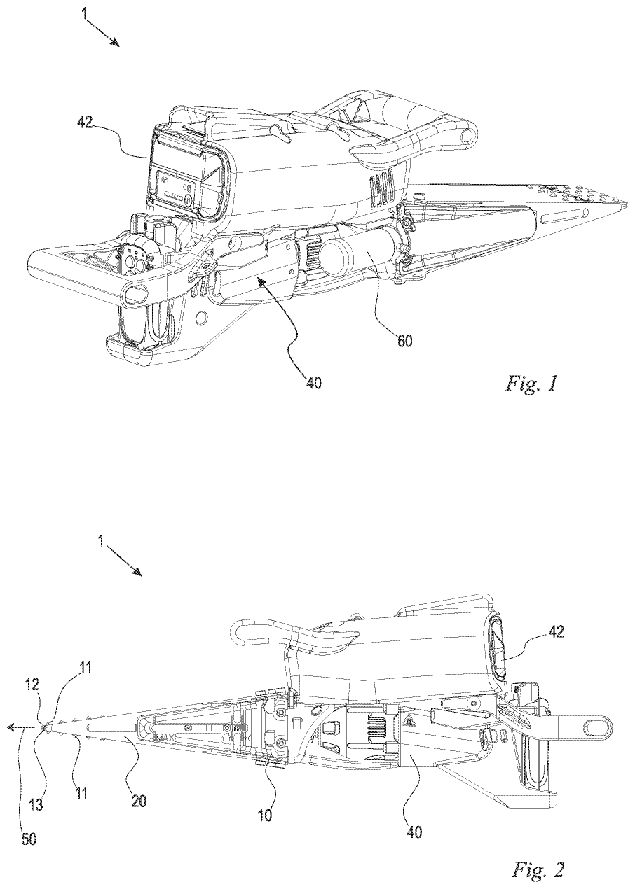

FIG. 1 shows a felling wedge 1. The felling wedge 1 is a work tool with which a tree to be felled is felled and can be guided in a desired direction as it falls. For this purpose, the felling wedge 1 is inserted into a pocket, in particular a wedge-shaped one, cut into the tree by a felling saw. Part of the felling wedge 1 is driven deeper into the pocket. Typically, this is carried out in the direction in which the tree to be felled is to fall.

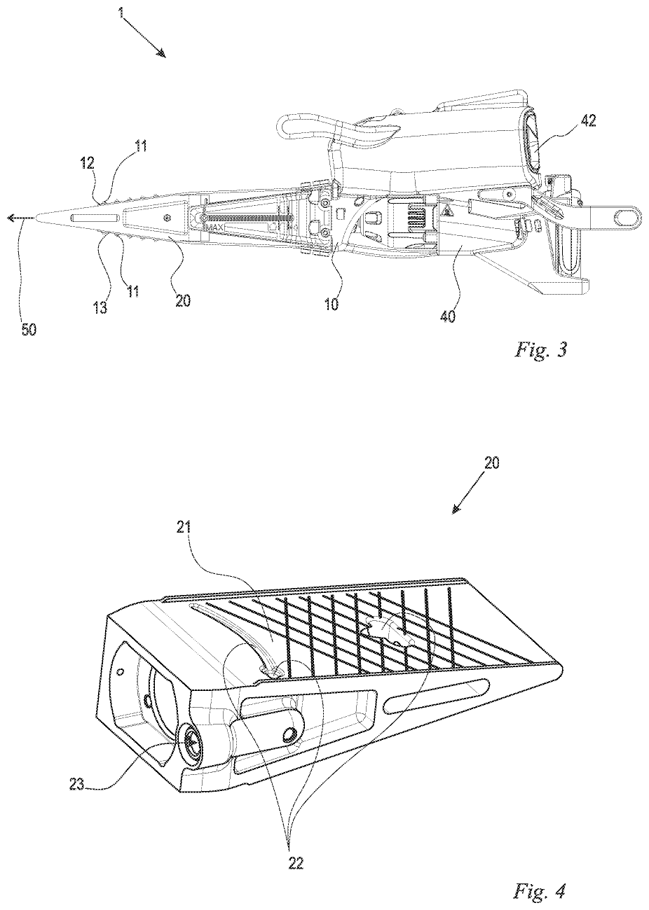

As depicted in particular in FIGS. 2 and 3, the felling wedge 1 comprises a base body 10 and a pressure wedge body 20. The pressure wedge body 20 is movable relative to the base body 10. When the tree is felled, the pressure wedge body 20 is driven into the pocket of the tree. The felling wedge 1 comprises a drive unit 40. The drive unit 40 serves to drive the pressure wedge body 20 into the pocket of the tree during felling the tree. The pressure wedge body 20 is substantially wedge-shaped, as can also be seen in FIG. 4.

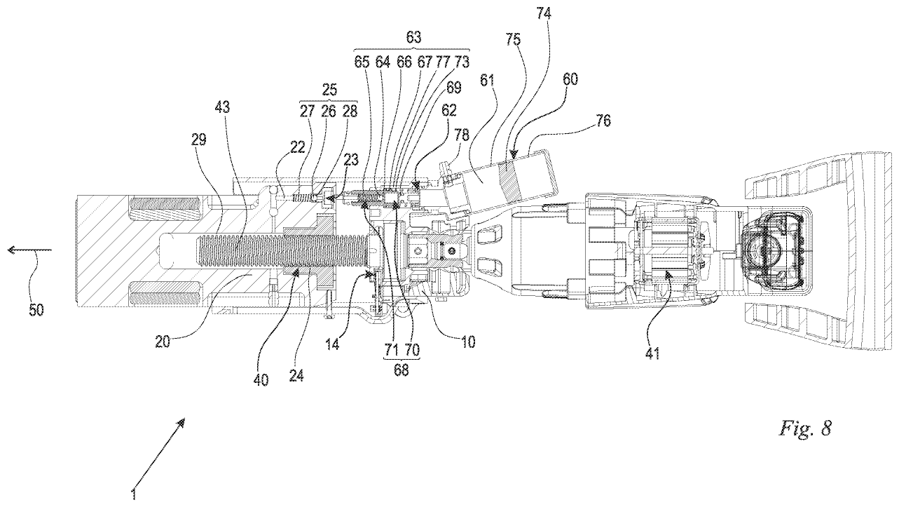

The felling wedge 1 is a mechanical felling wedge. It can be provided that the drive unit must be operated manually. In this case, the drive unit comprises a ratchet or similar. In the exemplary embodiments, the drive unit 40 comprises a motor 41 as depicted in FIG. 8. In the exemplary embodiments, the motor 41 is an electric motor. To supply power to the motor 41, the felling wedge 1 comprises a battery 42, as depicted in FIGS. 1 to 3.

The felling wedge 1 comprises at least one engagement mechanism 11, as depicted in FIGS. 2 and 3. The engagement mechanism 11 serves to engage the tree to be felled, in particular to engage the pocket. By means of the engagement mechanism 11, the base body 10 can be fixed relative to the tree to be felled, in particular relative to the pocket of the tree. When the base body 10 is fixed in the tree to be felled by means of the engagement mechanism 11, the pressure wedge body 20 can be extended relative to the base body 10 and thereby penetrate deeper into the pocket. Due to the wedge shape of the pressure wedge body 20, the pressure wedge body 20 enlarges the pocket and pushes the tree to be felled in the direction in which it is to fall. During this process, the base body 10 does not penetrate deeper into the pocket due to the fixation by the at least one engagement mechanism 11. The at least one engagement mechanism 11 has a tip with which it can engage the tree, in particular the pocket. In the exemplary embodiments, the at least one engagement mechanism 11 has the shape of a pointed pyramid with a round, in particular circular, base. In the exemplary embodiments, the at least one engagement mechanism 11 is pointedly conical.

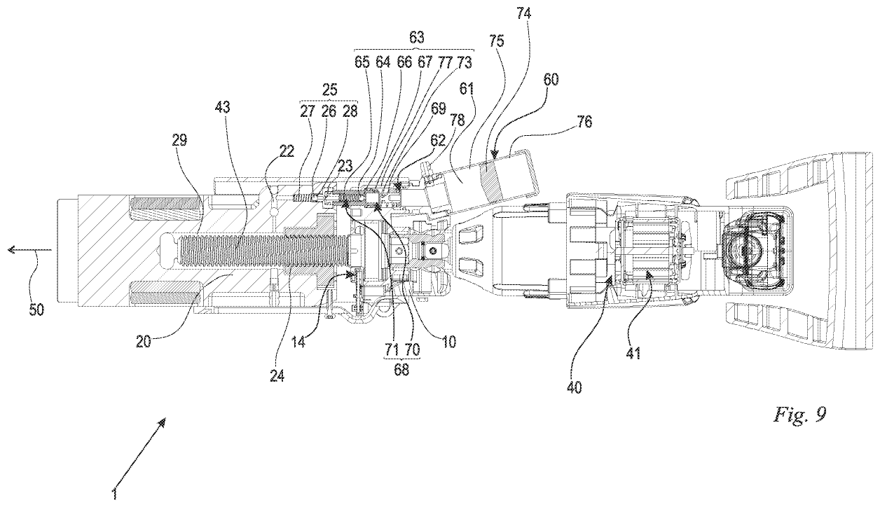

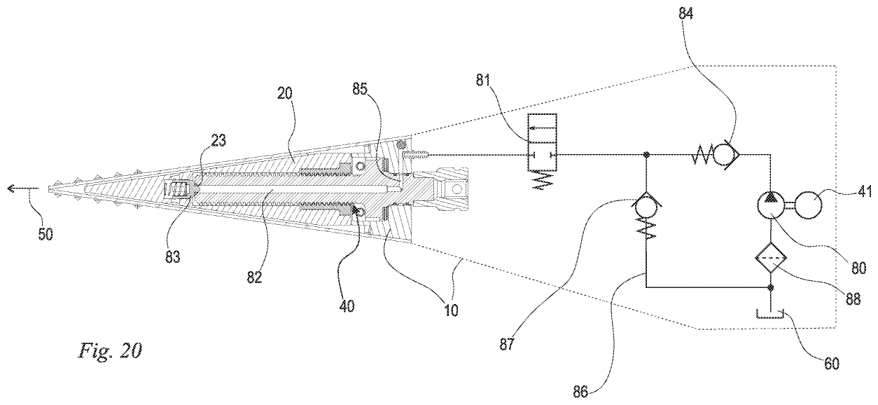

The felling wedge 1 comprises a lubricant tank 60, as depicted in FIG. 1. The lubricant tank 60 is fixed to the base body 10, as can also be seen, for example, in FIG. 8. The lubricant tank 60 is an integral part of the felling wedge 1. The lubricant tank 60 is allocated to the base body 10, such that the lubricant tank 60, together with the base body 10, is movable relative to the pressure wedge body 20. As depicted in FIGS. 8 to 10, the felling wedge 1 is formed in such a way that lubricant 61 can be conveyed from the lubricant tank 60 to the pressure wedge body 20. This applies to all exemplary embodiments. The alternative exemplary embodiments are depicted in FIGS. 20 to 22.

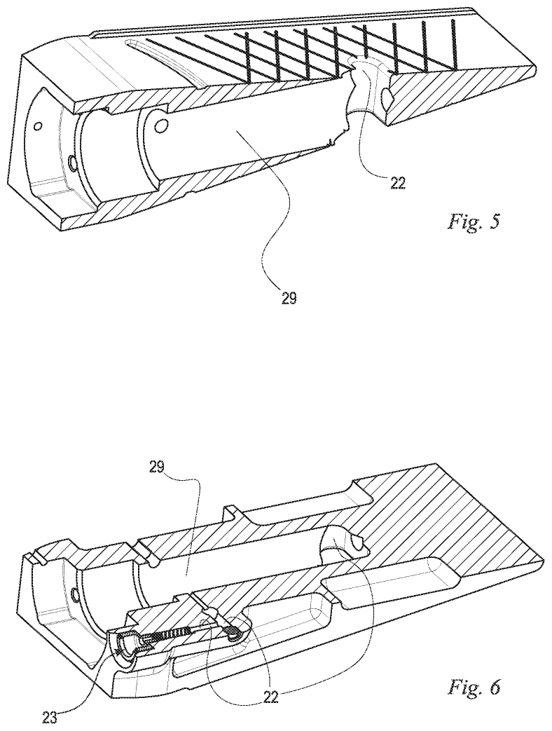

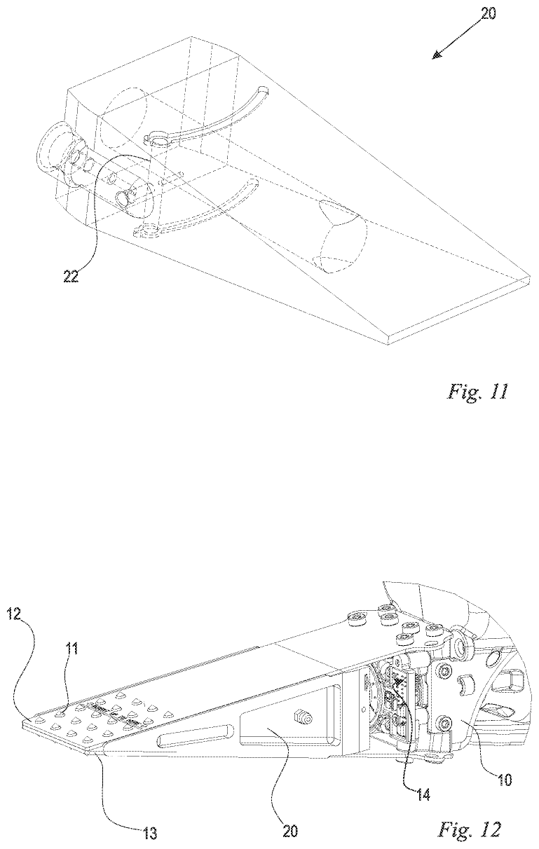

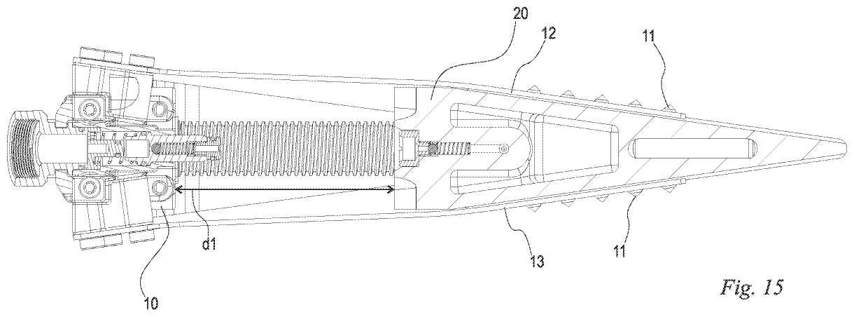

The lubricant 61 can be grease, in particular multi-purpose grease, or oil, in particular chain oil. In the exemplary embodiment according to FIGS. 1 to 19, the lubricant 61 is grease, in particular multi-purpose grease. In the exemplary embodiments according to FIGS. 20 to 24, the lubricant 61 is oil, in particular chain oil. The lubricant 61 can be filled, in particular refilled, into the lubricant tank 60 via a refill valve 78, for example depicted in FIG. 8. The capacity of the lubricant tank 60 is so large that the lubricant tank 60 can hold lubricant 61 for at least 50, in particular at least 100, in particular at least 500, lubrication cycles of the felling wedge 1.

In the exemplary embodiments shown in FIGS. 1 to 19 and 20, it applies that the lubricant 61 can be conveyed, at least indirectly, from the lubricant tank 60 to the pressure wedge body 20 by the drive unit 40. The energy of the drive unit 40 is used, at least indirectly, to convey lubricant 61 from the lubricant tank 60 to the pressure wedge body 20. In all exemplary embodiments, the drive unit 40 comprises the motor 41, with which the pressure wedge body 20 is movable relative to the base body 10. As depicted in FIGS. 2 and 3, the pressure wedge body 20 is movable relative to the base body 10 in a pressure direction 50. The pressure direction 50 runs in the longitudinal direction of the felling wedge 1. The pressure wedge body 20 tapers in the pressure direction 50. The pressure direction 50 points in the direction of the tip of the wedge-shaped pressure wedge body 20. In all embodiments, the pressure wedge body 20 is movable relative to the base body 10 by means of the motor 41 in the pressure direction 50 away from the base body 10 and against the pressure direction 50 towards the base body 10. An internal thread 24 is arranged in the pressure wedge body 20, as depicted in particular in FIGS. 8 to 10. In the exemplary embodiments, the internal thread 24 is arranged in a nut that is inserted into the pressure wedge body 20. However, it can also be provided that the internal thread is directly integrated into the pressure wedge body 20. In the exemplary embodiments, the nut is a threaded nut, in particular a trapezoidal threaded nut. In particular, the nut consists of red bronze. The nut is held in the pressure wedge body 20 in a rotationally fixed manner, in particular by fastening. A spindle 43 is screwed into the internal thread 24. The spindle 43 is mounted in the base body 10 of the felling wedge 1. In the exemplary embodiments, the spindle 43 is part of the drive unit 40. The spindle 43 can be driven, in particular rotatably, by means of the motor 41. The spindle 43, in particular the longitudinal direction of the spindle 43, extends in the pressure direction 50. The spindle 43 can be rotated around the pressure direction 50. By rotating the spindle 43, the pressure wedge body 20 can be moved away from the base body 10 in the pressure direction 50. By rotating the spindle 43 in the opposite direction, the pressure wedge body 20 can be brought closer to the base body 10, in particular in the direction opposite to the pressure direction 50. A receiving pocket 29 is provided for receiving the spindle in the pressure wedge body 20. The receiving pocket 29 extends from an entrance opening into the pressure wedge body 20 in the pressure direction 50. The receiving pocket 29 is formed as a blind hole. In the exemplary embodiments, the receiving pocket 29 is slightly conical for ease of demoulding. It can also be provided that the receiving pocket 29 is hollow cylindrical. In the exemplary embodiments, the internal thread 24, in particular the nut, is arranged in the region of the inlet opening of the receiving pocket 29.

In the exemplary embodiments according to FIGS. 1 to 19, the felling wedge 1 is designed in such a way that, due to a movement of the pressure wedge body 20 and the base body 10 towards each other caused by the drive unit 40, lubricant 61 can be conveyed from the lubricant tank 60. As depicted in particular in FIGS. 8 to 10, the lubricant tank 60 has an outlet opening 62. A valve device 63 is arranged at the outlet opening 62. In the closed state, the valve device 63 closes the outlet opening 62 of the lubricant tank 60. The valve device 63 can be opened by actuating it with the pressure wedge body 20.

In the exemplary embodiment, the valve device 63 comprises a valve member 64, as depicted in FIGS. 8 to 10. In the exemplary embodiment, the valve member 64 is a ball. The valve member 64 is pretensioned into a closed state of the valve device 63 by means of a return element 65. In the exemplary embodiments, the return element 65 is a spring. In the exemplary embodiments, the return element 65 exerts a force on the valve member 64, which acts in the opposite direction to the pressure direction 50. The valve device 63 has a valve seat 66. When the valve member 64 rests against the valve seat 66, the valve device 63 is closed. The return element 65 pretensions the valve member 64 in the direction of the valve seat 66.

The valve seat 66 is arranged on a shifting body 67. The shifting body 67 can be shifted relative to the outlet opening 62 of the lubricant tank 60 in the pressure direction 50 and against the pressure direction 50. The shifting body 67 has a shifting body channel 68. The shifting body channel 68 is formed inside the shifting body 67. The shifting body channel 68 completely penetrates the shifting body 67. The shifting body channel 68 runs in the pressure direction 50. The shifting body channel 68 has a closed cross-section. The valve member 64 is arranged in the shifting body channel 68. The valve seat 66 is arranged in the shifting body channel 68. The shifting body 67 has an outer peripheral wall. The valve device 63 comprises an outer housing 77. The outer housing 77 delimits a guide channel for the shifting body 67. In the exemplary embodiments, the outer housing 77 is formed by the base body 10. The outer housing 77 has an inner wall. The inner wall forms the guide channel. The guide channel is tubular. The guide channel, in particular the longitudinal direction of the guide channel, extends in the pressure direction 50. The outer housing 77 is in close proximity to the lubricant tank 60, in particular to the outlet opening 62 of the lubricant tank 60. The lubricant 61 flows out of the lubricant tank 60, in particular out of the outlet opening 62 of the lubricant tank 60, into the region delimited by the inner wall of the outer housing 77, in particular into the guide channel. The lubricant tank 60 and the region delimited by the inner wall of the outer housing 77, in particular the guide channel, are fluidically connected to each other. In the exemplary embodiments, this also applies to the closed state of the valve device 63.

The outer peripheral wall of the shifting body 67 lies close to the inner wall of the outer housing 77, in particular to the guide channel.

The valve seat 66, together with the shifting body 67, can be shifted relative to the outer housing 77 and/or relative to the lubricant tank 60. The shifting body 67 is shiftably mounted in the guide channel, in particular in the pressure direction 50 and against the pressure direction 50. By moving the shifting body 67 in the direction against the pressure direction 50, the lubricant 61 is compressed in the lubricant tank 60 and/or in the region upstream of the outlet opening 62 of the lubricant tank 60. In particular, the lubricant 61 is compressed in the guide channel, in particular in the region delimited by the inner wall of the outer housing 77, in particular upstream of the outlet opening 62. In doing so, the lubricant 61 exerts pressure on the valve member 64, in particular in the pressure direction 50. Thus, the valve device 63 is opened. The lubricant 61 can then pass through the valve seat 66 and advance through the shifting body channel 68 in the pressure direction 50. By moving the shifting body 67 in the direction opposite to the pressure direction 50, lubricant 61 can be conveyed out of the lubricant tank 60 in the direction of the pressure wedge body 20.

In the exemplary embodiment according to FIGS. 1 to 19, the shifting body 67 can be pushed into the lubricant tank 60 by the pressure wedge body 20 in the direction opposite to the pressure direction 50. In doing so, the valve device 63 is opened, and lubricant 61 is pumped from the lubricant tank 60 to the pressure wedge body 20. The pressure wedge body 20 is formed separately from the shifting body 67. The pressure wedge body 20 can be moved relative to the shifting body 67 in relation to the pressure direction 50 and in relation to the direction opposite to the pressure direction.

In all exemplary embodiments, the pressure wedge body 20 has a transfer point 23. Through the transfer point 23, lubricant 61 can enter the pressure wedge body 20 from the lubricant tank 60, which is fixed to the base body 10.

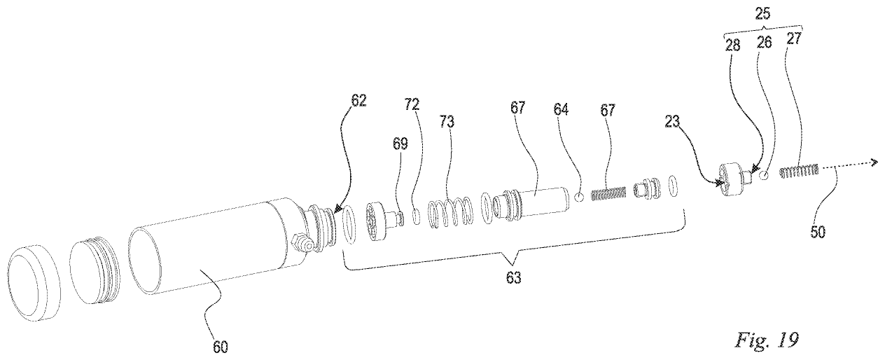

In the exemplary embodiment according to FIGS. 1 to 19, the valve device 63 can be actuated by means of the transfer point 23 of the pressure wedge body 20. The sliding body 67 is moved by the transfer point 23 in the direction opposite to the pressure direction 50, and the valve device 63 is opened. In doing so, the sliding body channel 68 is connected to the transfer point 23, in particular in a way that seals against the lubricant 61. The lubricant 61 can then pass through the sliding body channel 68 via the transfer point 23 into the pressure wedge body 20, in particular be conveyed. In the exemplary embodiment according to FIGS. 1 to 20, conveying is carried out by pressing lubricant 61 due to the movement of the sliding body 67 against the pressure direction 50. For this purpose, the lubricant tank 60 has a pressing stamp 69 at its outlet opening 62, which is depicted in FIGS. 8 to 10 and 19. The pressing stamp 69 is formed fixed to the lubricant tank 60, in particular to the outlet opening 62 of the lubricant tank 60. The pressing stamp 69 is arranged on the outlet opening 62 of the lubricant tank 60. As can be seen in FIG. 19, the pressing stamp 69 has a base plate on its side facing towards the outlet opening 62. The base plate has at least one penetration opening. Through the at least one penetration opening, the lubricant tank 60 is fluidically connected to the valve device 63, in particular in the region of the valve device 63 delimited by the inner wall of the outer housing 77, in particular in the guide channel.

The sliding body channel 68 has two partial sections. The two partial sections are separated from each other by the valve seat 66. The section of the sliding body channel 68 facing towards the lubricant tank 60 is referred to as the pressing chamber 70. The section of the sliding body channel 68 that is facing away from the lubricant tank 60 is referred to as the outlet chamber 71. In the unactuated state of the valve device 63, the pressing chamber 70 is filled with lubricant 61. Upon actuation of the valve device 63, the sliding body 67, and thus also the pressing chamber 70, is brought close to the lubricant tank 60, in particular to the outlet opening 62 of the lubricant tank 60. As the sliding body 67 approaches the pressing stamp 69, the pressing stamp 69 penetrates the pressing chamber 70. In this state, the pressing stamp 69 is in close contact with the pressing chamber 70. For this purpose, a sealing ring 72 depicted in FIG. 19 is arranged between the pressing chamber 70 and the pressing stamp 69 in this state.

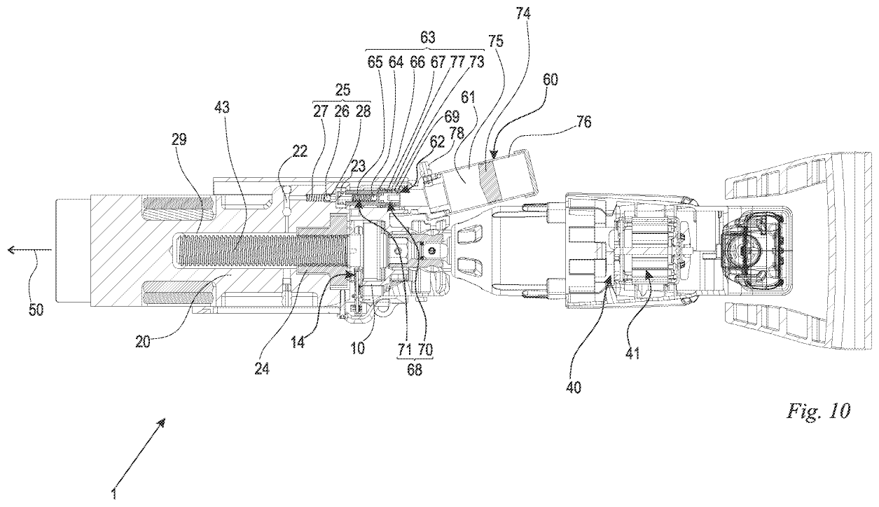

Between the end face of the pressing stamp 69 and the valve seat 66, which is still closed by the valve member 64, an externally sealed volume of the pressing chamber 70 is formed. In this volume of the pressing chamber 70 there is a defined volume of lubricant 61. As the shifting body 67 approaches the pressing stamp 69 further, the pressing stamp 69 forces the lubricant 61 in the pressing chamber 70 in the direction of the valve member 64. Thus, the valve member 64 is moved away from the valve seat 66 against the return force of the return element 65. Thus, the valve device 63, and the lubricant 61 in the pressing chamber 70 can enter the outlet chamber 71 of the sliding body 67. The lubricant 61 is pressed out of the pressing chamber 70 into the outlet chamber 71. The sliding body 67 is moved by the pressure wedge body 20 in the opposite direction to the pressure direction 50 until the pressing stamp 69 abuts on the bottom of the pressing chamber 70. Thus, the opening formed by the valve seat is closed by means of the pressing stamp 69. This state is depicted in FIG. 10. All the lubricant 61 previously located in the pressing chamber 70 is pressed out of the pressing chamber 70 into the outlet chamber 71.

The valve device 63 is designed in such a way that, during a single actuation process, only a defined volume of lubricant 61 can be conveyed through the valve device 63 from the lubricant tank 60 to the pressure wedge body 20. To allow more lubricant 61 to be conveyed from the lubricant tank 60 into the pressure wedge body 20, the actuation of the valve device 63 must first be stopped. In particular, the pressure wedge body 20 must be removed from the base body 10 for this purpose.

After the actuation of the valve device 63 by the pressure wedge body 20 has ended, the valve device 63 closes automatically. The sliding body 67 is pretensioned in the pressure direction 50 by means of a sliding return element 73. The sliding return element 73 acts between the lubricant tank 60, in particular the outlet opening 62 of the lubricant tank 60, and the sliding body 67. In the exemplary embodiments, the sliding return element 73 is supported on the lubricant tank 60, in particular the outlet opening 62 of the lubricant tank 60, and the sliding body 67. In the exemplary embodiments, the sliding return element 73 is a spring. The sliding return element 73 pushes the shifting body 67 away from the lubricant tank 60. At this point in time, the valve device 63 is already closed again. The pressing process is complete, and pressure is no longer exerted on the valve member 64 by the expulsion of lubricant 61 from the pressing chamber 70. The movement of the shifting body 67 in the direction away from the lubricant tank 60 creates a vacuum, in particular in the region in front of the outlet opening 62 of the lubricant tank 60, in particular in the region of the guide channel sealed by the shifting body 67, in particular in front of the outlet opening 62. As soon as the pressing stamp 69 no longer seals against the pressing chamber 70, in particular when removed from the pressing chamber 70, a vacuum also emerges in the pressing chamber 70 as the shifting body moves in the pressure direction 50. The vacuum causes lubricant 61 to be drawn out of the lubricant tank 60, in particular into the region in front of the outlet opening 62 of the lubricant tank 60, in particular into the region of the guide channel sealed by the shifting body 67, in particular in front of the outlet opening 62, in particular into the pressing chamber 70. In doing so, the tank stamp body 74 depicted in FIGS. 8 to 10 is moved.

The tank stamp body 74 is arranged in the lubricant tank 60. The tank stamp body 74 separates a lubricant chamber 75 and an air chamber 76 of the lubricant tank 60 from each other. The tank stamp body 74 seals the lubricant chamber 75 from the air chamber 76. The tank stamp body 74 rests against an inner peripheral wall of the lubricant tank 60. The tank stamp body 74 is moveably mounted in the lubricant tank 60. When the shifting body 67 is moved away from the lubricant tank 60 due to the action of the sliding return element 73, the volume of the lubricant chamber 75 is reduced. The tank stamp body 74 is moved in the direction of the pressure wedge body 20. The volume of the air chamber 76 is here increased. Air is drawn into the air chamber 76 from the surroundings.

After lubricant 61 has been pressed from the outlet chamber 71 of the shifting body channel 68 into the pressure wedge body 20, in particular into the transfer point 23, lubricant 61 reaches the pressure wedge body 20 from the lubricant tank 60. As depicted in FIGS. 8 to 10, the pressure wedge body 20 has at least one channel 22. The at least one channel 22 has a closed cross-section. Lubricant 61 can be conveyed through the at least one channel 22. A check valve 25 is arranged between the transfer point 23 and the at least one channel 22. The check valve 25 comprises a check valve member 26, a check valve return element 27, and a check valve seat 28. In the exemplary embodiment according to FIGS. 1 to 19, the check valve return element 27 is a spring. The force of the check valve return element 27 acts in the opposite direction to the pressure direction 50. The check valve 25 prevents the lubricant 61 from flowing back out of the at least one channel 22 into the transfer point 23. Lubricant 61 flowing in the direction from the at least one channel 22 towards the transfer point 23 exerts a force on the check valve 25, in particular on the check valve member 26, in the direction of the closed state of the check valve 25. The check valve member 26 is here pressed against the check valve seat 28.

Thus, the lubricant 61 is prevented from flowing back out of the pressure wedge body 20. When lubricant 61 is pressed from the lubricant tank 60 into the pressure wedge body 20, the check valve 25 here opens. The compressed lubricant 61 exerts a force on the check valve 25, in particular on the check valve member 26, in the direction of the open state of the check valve 25. This force acts in the pressure direction 50. In doing so, the check valve member 26 is moved away from the check valve seat 28 against the force of the check valve return element 27. Thus, lubricant 61 can penetrate from the transfer point 23 into the at least one channel 22.

In all exemplary embodiments, the felling wedge 1 is formed in such a way that lubricant 61 is conveyed from the lubricant tank 60 to the pressure wedge body 20 with each complete retraction of the pressure wedge body 20 against the base body 10. In the exemplary embodiment according to FIGS. 1 to 19, the valve device 63 is actuated by the pressure wedge body 20, in particular by the transfer point 23 of the pressure wedge body 20, with each complete retraction of the pressure wedge body 20 against the base body 10, and thus the valve device 63 is opened. The predefined volume of lubricant 61 is pressed into the pressure wedge body 20. There it is used to lubricate the pressure wedge body 20 and/or the drive unit 40.

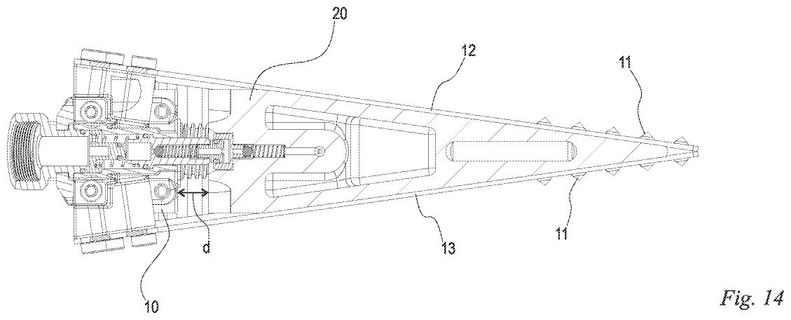

In all exemplary embodiments, the felling wedge 1 is formed in such a way that conveying lubricant 61 from the lubricant tank 60 to the pressure wedge body 20 is carried out depending on a parameter or a lubricant signal generated by the user. The parameter can, in particular, be a threshold value. As long as the threshold value is not exceeded, no lubricant 61 is conveyed from the lubricant tank 60 to the pressure wedge body 20. In the exemplary embodiment according to FIGS. 1 to 19, this is achieved by preventing actuation of the valve device 63 by the pressure wedge body 20, in particular by the transfer point 23. At least one limit distance d, depicted in FIG. 14, is then maintained between the pressure wedge body 20 and the base body 10. In the exemplary embodiment according to FIGS. 1 to 19, the limit distance d is measured in the pressure direction 50. As long as the distance between the wedge body 20 and the base body 10 at least corresponds to the limit distance d, the shifting body 67 is not moved by the pressure wedge body 20, in particular not by the transfer point 23. The valve device 63 remains closed, and no lubricant 61 is conveyed. The limit distance d is the smallest distance, measured in the pressure direction 50, between the pressure wedge body 20 and the base body 10 at which the valve device 63 is just not actuated. In particular, the valve device 63 is actuated when it is moved, in particular when the shifting body 67 is moved.

In all exemplary embodiments, the felling wedge 1 is designed in such a way that it can be brought into a conveying stop mode by a conveying stop signal generated by the user. In the conveying stop mode, conveying lubricant 61 from the lubricant tank 60 to the pressure wedge body 20 is prevented or is not triggered. In the exemplary embodiment according to FIGS. 1 to 19, the conveying stop signal ensures that at least the minimum distance d is maintained between the pressure wedge body 20 and the base body 10.

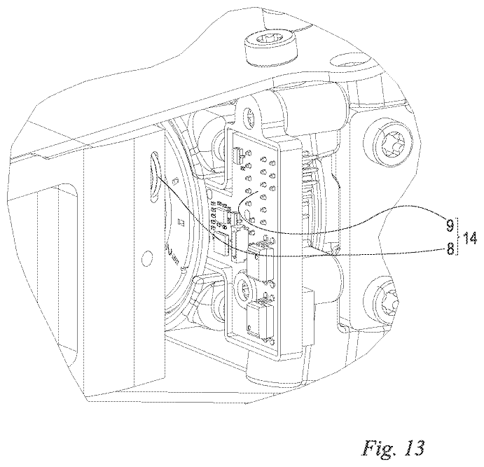

In the exemplary embodiment according to FIGS. 1 to 19, the felling wedge 1 comprises a distance detector 14 (FIG. 13). The distance detector 14 detects the distance between the pressure wedge body 20 and the base body 10, in particular with respect to the pressure direction 50. It can be checked by means of the distance detector 14 whether the distance between the pressure wedge body 20 and the base body 10 corresponds to the limit distance d. If this is the case and the felling wedge 1 is in conveying stop mode or the corresponding parameter, in particular the corresponding threshold value, is not present, further approach of the pressure wedge body 20 and the base body 10 is prevented. In the exemplary embodiment according to FIGS. 1 to 19, this is achieved by the drive unit 40, in particular the motor 41, no longer being driven.

In all exemplary embodiments, the felling wedge 1 comprises a control unit not depicted. The conveying stop signal generated by the user is supplied to the control unit. Upon receiving the conveying stop signal, the control unit puts the felling wedge 1 into conveying stop mode. In the exemplary embodiment according to FIGS. 1 to 19, this is achieved by the control unit causing the power supply to the motor 41 of the drive unit 40 to be interrupted.

The distance detector 14 depicted in FIG. 13 comprises a magnet 8 and a Hall sensor 9. In the exemplary embodiments, the magnet 8 is arranged on the pressure wedge body 20. The Hall sensor 9 is arranged on the base body 10. The magnet 8 and the Hall sensor 9 are arranged relative to each other in such a way that they are on a line with respect to the pressure direction 50.

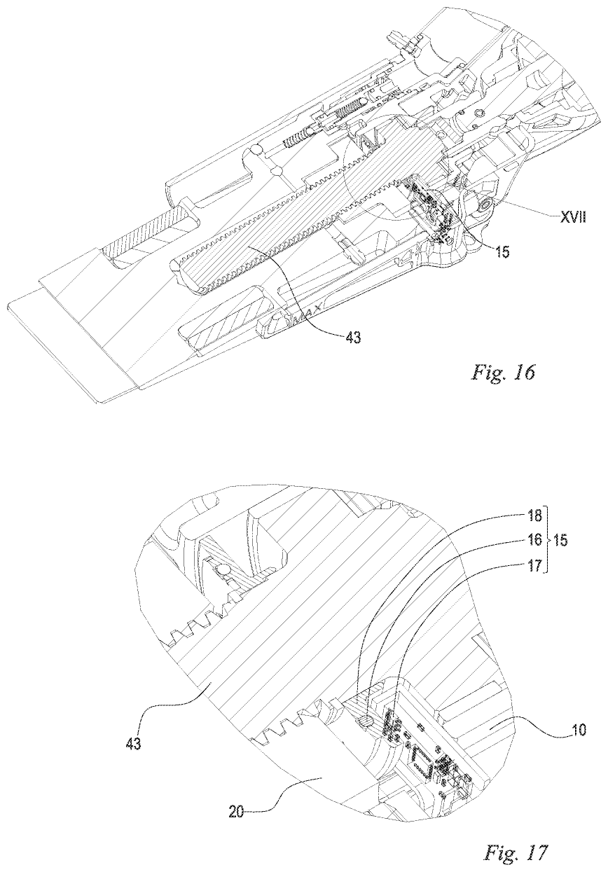

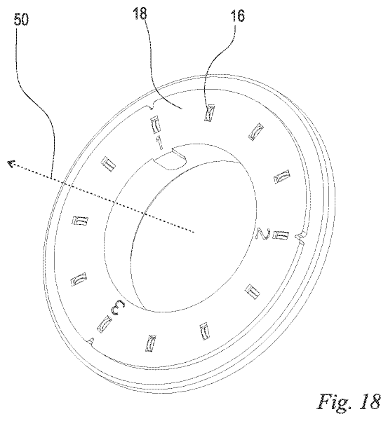

The parameter that determines the conveying of lubricant 61 from the lubricant tank 60 to the pressure wedge body 20 is carried out, based in all exemplary embodiments on the number of forward and/or backward movements of the pressure wedge body 20 relative to the base body 10 and/or the number of engagements of the felling wedge 1, in particular the pressure wedge body 20 under load. In all exemplary embodiments, it can be detected by means of the distance detector 14 how often the limit distance d between the pressure wedge body 20 and the base body 10 is not met. From this, the control unit can ascertain the number of forward and/or backward movements of the pressure wedge body 20 relative to the base body 10. Alternatively or additionally, the number of revolutions of the spindle 43, in particular the angular position of the spindle 43, can be measured by means of an angle detector 15, as it is depicted in FIGS. 16 to 18. In the exemplary embodiments, the angle detector 15 comprises a magnet 16, a Hall sensor 17, and a rotary wheel 18, as depicted in FIG. 17. The magnet 16 is held on the rotary wheel 18. The rotary wheel 18 is connected to the spindle 43 in a rotationally fixed manner. The Hall sensor 17 is arranged fixed to the base body 10. When the spindle 43 is rotated by means of the drive unit 40, in particular by means of the motor 41, the rotary wheel 18, which is connected to the spindle 43 in a rotationally fixed manner, is rotated. The magnet 16 is rotated by the rotary wheel 18. The Hall sensor 17 and the magnet 16 are arranged relative to each other in such a way that the magnet 16 passes the Hall sensor 17 during the rotation of the rotary wheel 18 in such a way that this can be detected by the Hall sensor 17. As depicted in FIG. 18, several magnets 16 are arranged on the rotary wheel 18 in the exemplary embodiments. In the exemplary embodiments, twelve magnets 16 are evenly distributed around the periphery of the annular rotary wheel 18. The magnets 16 are arranged at equal angular intervals, in particular with respect to a central axis of the rotary wheel 18 running in the pressure direction 50. The control unit receives information about how many magnets 16 have passed the Hall sensor 17 in which direction of rotation of the rotary wheel 18. From this, the control unit can ascertain the position of the pressure wedge body 20 on the spindle 43. This information can be used to ascertain the number of forward and/or backward movements of the pressure wedge body 20 relative to the base body 10. In particular, it can be stipulated that only a movement in which the pressure wedge body 20 has travelled a certain distance counts as a forward movement and/or a backward movement. Thus, small forward and/or backward movements can be disregarded.

In all exemplary embodiments, the control unit is supplied with information about the electrical energy supplied to the motor, in particular the current strength of the current flowing through the motor 41. Based on this information, the control unit can ascertain the number of engagements of the felling wedge 1, in particular the pressure wedge body 20, under load. In the exemplary embodiments, the felling wedge 1, in particular the control unit of the felling wedge 1, can be set in such a way that lubricant 61 is only conveyed from the lubricant tank 60 to the pressure wedge body 20 when the pressure wedge body 20 has already been moved forward under load relative to the base body 10 two, in particular three, in particular a predeterminable number of times. A forward movement is carried out in the pressure direction 50. When the pressure wedge body 20 has only been moved forward once, it can be provided that it is only moved back from the drive unit 40 to such an extent that at least the limit distance d is maintained between the pressure wedge body 20 and the base body 10. This simply prevents the valve device 63 from being actuated and the lubricant 61 from being conveyed from the lubricant tank 60 to the pressure wedge body 20. It can be provided that the pressure wedge body 20 can only be moved back far enough to actuate the valve device 63 after two successive forward movements.

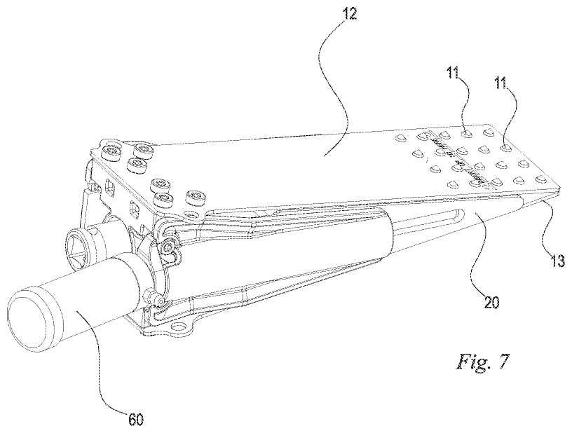

In all exemplary embodiments, the felling wedge 1 comprises two wedge jaws 12 and 13. This is particularly evident in FIGS. 7, 12, 14, and 15. The wedge jaws 12 and 13 are also referred to as retaining plates or spring steel plates. The two wedge jaws 12 and 13 are each provided for arranging between the tree, in particular the wedge-shaped pocket, and the pressure wedge body 20. The two wedge jaws 12 and 13 are fixed to the base body 10. The pressure wedge body 20 is movable relative to the two wedge jaws 12 and 13. The two wedge jaws 12 and 13 each contact the pressure wedge body 20 in a contact region 21. The contact region 21 is depicted in FIG. 4. The pressure wedge body 20 is arranged between the two wedge jaws 12 and 13. The upper wedge jaw 12 abuts on the pressure wedge body 20. The lower wedge jaw 13 abuts on the pressure wedge body 20. The contact surface between the pressure wedge body 20 and the upper wedge jaw 12 forms the contact region 21. The contact surface between the lower wedge jaw 13 and the pressure wedge body 20 forms the contact region 21. The lubricant 61 is also provided for lubricating the contact region 21. As can be seen when looking at FIGS. 4 to 6 and 11 together, the lubricant 61 can be conveyed to the contact region 21 through the at least one channel 22. The lubricant enters the pressure wedge body 20 through the transfer point 23 and from there reaches the at least one channel 22. The at least one channel 22 at least also leads to the contact region 21. Lubricant 61 can be conveyed from the lubricant tank 60 to the contact region 21 through the at least one channel 22. As can be seen in particular in FIG. 6 and FIG. 8, lubricant 61 is also conveyed to the drive unit 40, in particular to the spindle 43, in particular to the internal thread 24, and in particular to the receiving pocket 29, by means of the at least one channel 22. The at least one channel 22 leads from the transfer point 23 to the receiving pocket 29 of the pressure wedge body 20. The lubricant 61 is pressed through the at least one channel 22 to the drive unit 40, in particular to the spindle 43, in particular to the internal thread 24, in particular to the receiving pocket 29. Thus, this region is also lubricated.

To improve the distribution of the lubricant 61 over the entire contact region 21, linear indentations are introduced into the surface of the pressure wedge body 20, which forms the contact region 21. In the exemplary embodiments, the indentations are arranged in a herringbone pattern on the surface of the pressure wedge body 20. The indentations are arranged both on the top of the pressure wedge body 20 and on the bottom of the pressure wedge body 20.

In the exemplary embodiment according to FIGS. 1 to 19, the felling wedge 1 is designed, as described, in such a way that lubricant 61 can be conveyed out of the lubricant tank 60 due to the movement of the pressure wedge body 20 and the base body 10 towards each other, caused by the drive unit 40. In the exemplary embodiment according to FIG. 20, the lubricant 61 is conveyed in a different manner. In this exemplary embodiment, a conveying pump 80 is provided. The conveying pump 80 is driven by the motor 41 of the drive unit 40 to move the pressure wedge body 20 relative to the base body 10. The conveying pump 80 is fixed to the base body 10.

By means of a switching valve 81, the supply of lubricant 61 out of the lubricant tank 60 to the pressure wedge body 20 can be interrupted. In the exemplary embodiment according to FIG. 20, the switching valve 81 is pretensioned in the interrupted state. When lubrication of the felling wedge 1 is desired, the user can actuate the switching valve 81.

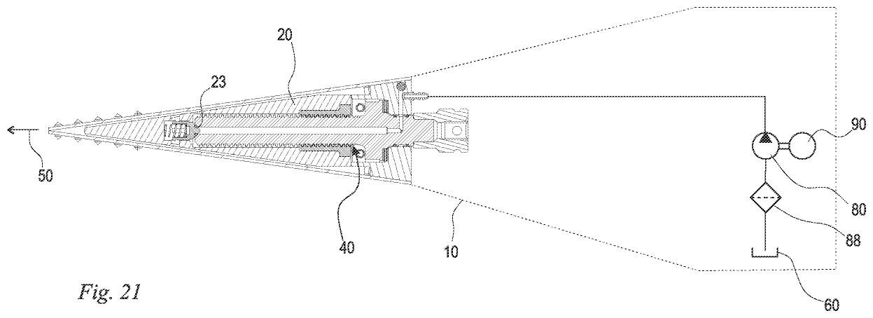

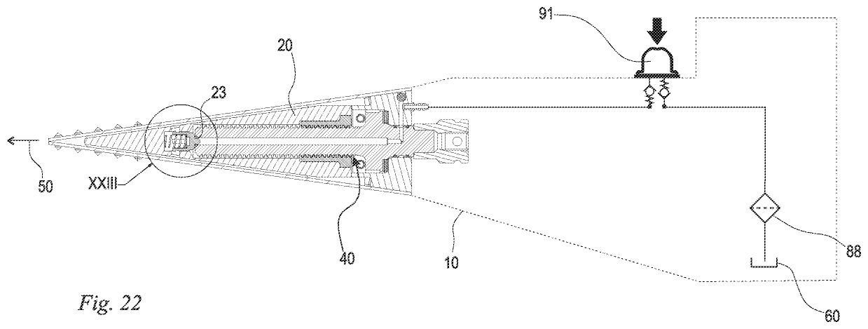

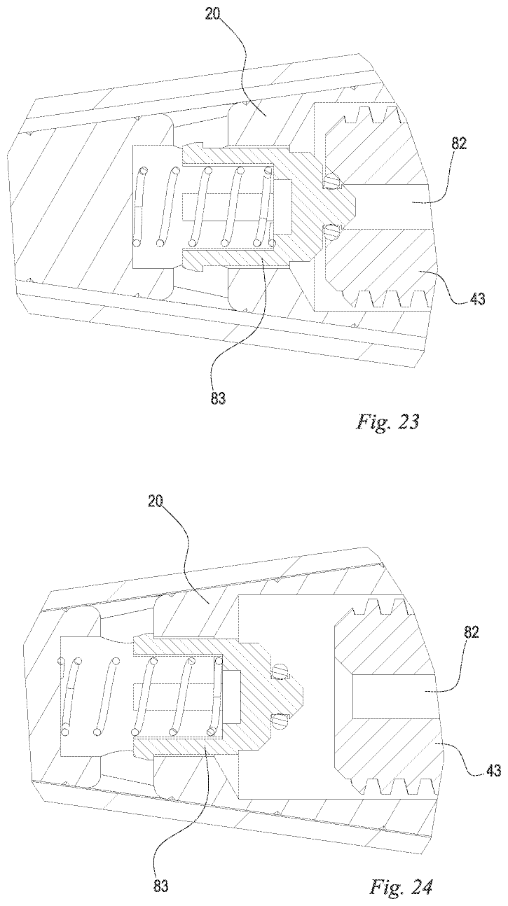

In the exemplary embodiment according to FIG. 20 (and FIGS. 21 and 22), the spindle 43 has a hollow channel 82. The hollow channel 82 extends in the pressure direction 50 starting from the region of the spindle 43, which is arranged in the region of the base body 10, to the end face of the spindle 43, which is facing towards the pressure wedge body. The hollow channel 82 is open at the end face of the spindle 43. The hollow channel 82 is a blind bore that is introduced into the spindle 43 from the opening at the end face. At the end of the hollow channel 82 opposite the end face, the spindle 43 has a transverse bore 85 running radially to the longitudinal direction of the hollow channel 82, in particular radially to the pressure direction 50. Lubricant 61 can enter the spindle 43 from the base body 10 via the transverse bore 85. For this purpose, a peripheral annular gap is provided in the spindle 43. The annular gap is sealed against the base body 10 by means of two O-rings. The spindle 43 is rotatably mounted in the base body 10. In the exemplary embodiment according to FIG. 20, the transfer point 23 is arranged on the end face of the spindle 43. The transfer point 23 can be closed by means of a spindle valve 83. The spindle valve 83 is pretensioned into the closed state. The spindle valve 83 is fixed on the pressure wedge body 20. When the end face of the spindle 43 is sufficiently close to the spindle valve 83, i.e. when the pressure wedge body 20 is largely retracted, the spindle valve 83 can close the transfer point 23. This situation is depicted in FIG. 23 for the exemplary embodiments according to FIGS. 20 to 22. When the end face of the spindle 43 is too far removed from the spindle valve 83, the spindle valve 83 cannot fundamentally close the transfer point 23, as depicted in FIG. 24 by way of example for the exemplary embodiments according to FIGS. 20 to 22. The spindle valve 83 can provide leakage protection when it closes the transfer point 23. This prevents lubricant 61, in particular oil, especially chain oil, from unintentionally flowing out of the hollow channel 82 into the pressure wedge body 20. Moreover, the spindle valve 83 prevents lubricant 61, which has already been conveyed into the pressure wedge body 20, from flowing back into the hollow channel 82. When lubricant 61 is conveyed into the pressure wedge body 20, the spindle valve 83 is opened by the pressure exerted on the check valve 83 by the lubricant 61.

In the exemplary embodiment according to FIG. 20, when the drive unit 40, in particular the motor 41, rotates in the direction of rotation that causes the pressure wedge body 20 to be moved towards the base body 10, lubricant 61 is conveyed out of the lubricant tank 60 to the pressure wedge body 20 by means of the conveying pump 80. When the drive unit 40, in particular the motor 41, rotates in the opposite direction of rotation, such that the pressure wedge body 20 is moved away from the base body 10, the conveying pump 80 would convey lubricant 61 in the opposite direction. In order to prevent this, in the exemplary embodiment according to FIG. 20, a reverse-rotation check valve 84 is arranged in the supply line to the spindle 43, in particular between the spindle 43 and the conveying pump 80. The reverse-rotation check valve 84 is pretensioned towards the conveying pump 80. In particular, the reverse-rotation check valve 84 is arranged between the switching valve 81 and the conveying pump 80.

When the switching valve 81 is in the closed state, conveying lubricant 61 to the pressure wedge body 20 is prevented. The pressure in the supply line upstream of the switching valve 81 increases when the drive unit 40, in particular the motor 41, is operated in the corresponding conveying direction. In order to prevent the conveying pump 80 from working against the closed switching valve 81 and the pressure in the supply line from continuously increasing, a bypass line 86 is provided. The bypass line 86 connects the supply line in the region between the switching valve 81 and the conveying pump 80, in particular between the switching valve 81 and the reverse-rotation check valve 84, to a region of the supply line upstream of the conveying pump 80. Thus, the lubricant 61 can be conveying in a circle by the conveying pump 80. A bypass valve 87 is arranged in the bypass line 86. The bypass valve 87 is pretensioned in the direction of the region of the supply line downstream of the conveying pump 80. The bypass valve 87 ensures that lubricant 61 can only be conveyed through the bypass line 86 in the direction from the region downstream of the conveying pump 80 to the region upstream of the conveying pump 80.

A filter 88 is arranged between the lubricant tank 60 and the conveying pump 80. The filter 88 serves to filter the lubricant 61. The bypass line 86 supplies the lubricant 61 to the region upstream of the conveying pump 80 in the region of the supply line between the filter 88 and the lubricant tank 60.

In the exemplary embodiment according to FIG. 20, the lubricant tank 60 is fixed to the base body 10. The lubricant tank 60 is fixedly connected to the base body 10.

FIG. 21 shows a further alternative exemplary embodiment. This exemplary embodiment differs from the exemplary embodiment according to FIG. 20 in that a conveying pump drive 90 formed separately from the drive unit 40 for moving the pressure wedge body 20 relative to the base body 10, in particular separately from the motor 41, is provided for driving the conveying pump 80. A conveying device formed separately from the drive unit 40 is provided for conveying the lubricant 61 from the lubricant tank 60 to the pressure wedge body 20. The conveying pump 80 can be driven independently of the drive unit 40, in particular of the motor 41. Thus, the direction of rotation of the motor 41 of the drive unit 40 does not need to be taken into consideration. The conveying pump drive 90 can always be operated in the same direction. This makes the reverse-rotation check valve 84 and the bypass line 86 together with the bypass valve 87 superfluous. A switching valve 81 also does not have to be provided. The lubricant 61 can be specifically conveyed by means of the conveying pump drive 90 only when lubricant 61 is also actually required to be conveyed into the pressure wedge body 20. This can be controlled by supplying energy to the conveying pump drive 90 only when lubricant 61 is also to be conveyed. Only in this case is the conveying pump 80 driven by the conveying pump drive 90. When the conveying pump drive 90 is not supplied with energy, the conveying pump 80 remains stationary, and no lubricant 61 is conveyed. The conveying pump drive 90 is, in particular, a motor, specifically an electric motor.

Instead of the hydraulic switching valve 81, an electric switch or button can be provided with which the conveying pump drive 90 can be switched on or off. In the exemplary embodiment according to FIG. 21, the lubricant tank 60 is also fixed to the base body 10. The lubricant tank 60 is fixed to the base body 10.

In FIG. 22, a further alternative exemplary embodiment is shown. In this exemplary embodiment, in contrast to the exemplary embodiment according to FIG. 21, a manual conveying pump 91 is provided instead of the conveying pump 80 that can be driven by means of the conveying pump drive 90. The manual conveying pump 91 is driven by hand. Thus, no conveying pump drive is required. The manual conveying pump 91 comprises two check valves. The first check valve prevents the conveyance of lubricant 61 in the direction upstream of the manual conveying pump. The second check valve prevents the backflow of lubricant 61 from the region downstream of the manual conveying pump 91 into the manual conveying pump 91. The operator can apply pressure to a diaphragm of the manual pump 91. In doing so, the second check valve is opened. When the diaphragm returns to its original position, a vacuum is created in the manual conveying pump 91. The vacuum causes lubricant 61 to be drawn out of the region of the supply line upstream of the manual conveying pump 91, in particular out of the lubricant tank 60. Thus, a diaphragm chamber of the manual conveying pump 91 is filled with lubricant. By actuating the manual conveying pump 91 again, the lubricant 61 drawn into the diaphragm chamber can be manually pressed into the region of the supply line downstream of the manual conveying pump 91.

The description of the exemplary embodiment according to FIG. 20 also applies to the exemplary embodiments according to FIGS. 21 and 22, except for the differences described.

1.-16. (canceled)

17. A felling wedge, comprising:
a base body (10);
at least one engagement mechanism (11) configured to engage a tree to be felled and to fix the base body (10) relative to the tree;
a pressure wedge body (20) movable relative to the base body (10);
a drive unit (40) configured to move the pressure wedge body (20) relative to the base body (10); and
a lubricant tank (60) fixed to the base body (10),
wherein lubricant (61) is conveyable from the lubricant tank (60) to the pressure wedge body (20).

18. The felling wedge according to claim 17,
wherein the lubricant (61) is conveyable from the lubricant tank (60) to the pressure wedge body (20) through the drive unit (40).

19. The felling wedge according to claim 17,
wherein the drive unit (40) comprises a motor (41) configured to move the pressure wedge body (20) relative to the base body (10).

20. The felling wedge according to claim 17,
wherein conveyance of the lubricant (61) from the lubricant tank (60) to the pressure wedge body (20) is controlled based on a parameter or a lubricant signal generated by a user.

21. The felling wedge according to claim 20,
wherein the parameter is based on at least one of
a number of forward movements of the pressure wedge body (20) relative to the base body (10),
a number of backward movements of the pressure wedge body (20) relative to the base body (10), or
a number of uses of the felling wedge (1) under load.

22. The felling wedge according to claim 17,
wherein the felling wedge (1) is configured such that, during each complete retraction of the pressure wedge body (20) toward the base body (10), the lubricant (61) is conveyed from the lubricant tank (60) to the pressure wedge body (20).

23. The felling wedge according to claim 17,
wherein the felling wedge (1) comprises two wedge jaws (12, 13), each wedge jaw (12, 13) being configured for arrangement between the tree and the pressure wedge body (20),
wherein the two wedge jaws (12, 13) are fixed to the base body (10),
wherein the pressure wedge body (20) is movable relative to the two wedge jaws (12, 13),
wherein each of the two wedge jaws (12, 13) contacts the pressure wedge body (20) in a contact region (21), and
wherein the lubricant (61) is configured to lubricate at least the contact region (21).

24. The felling wedge according to claim 23,
wherein the at least one engagement mechanism (11) is formed on the wedge jaws (12, 13).

25. The felling wedge according to claim 23,
wherein the pressure wedge body (20) has at least one channel (22) configured to convey the lubricant (61) from the lubricant tank (60) to the contact region (21).

26. The felling wedge according to claim 25,
wherein the pressure wedge body (20) has a transfer point (23) through which the lubricant (61) is receivable from the lubricant tank (60) into the at least one channel (22).

27. The felling wedge according to claim 17,
wherein the felling wedge (1) is configured such that, in response to movement of the pressure wedge body (20) and the base body (10) toward each other by the drive unit (40), the lubricant (61) is conveyable out of the lubricant tank (60).

28. The felling wedge according to claim 17,
wherein the lubricant tank (60) has an outlet opening (62),
wherein a valve device (63) is arranged at the outlet opening (62), and
wherein the valve device (63) is openable by actuation with the pressure wedge body (20).

29. The felling wedge according to claim 28,
wherein the valve device (63) is configured to close automatically after the actuation has ended.

30. The felling wedge according to claim 28,
wherein the valve device (63) is configured such that, during a single actuation process, only a defined volume of the lubricant (61) is conveyable through the valve device (63) from the lubricant tank (60) to the pressure wedge body (20).

31. A method of operating a felling wedge,
the felling wedge (1) comprising a base body (10), at least one engagement mechanism (11), a pressure wedge body (20) movable relative to the base body (10), a drive unit (40), and a lubricant tank (60) fixed to the base body (10),
the method comprising:
engaging, by the at least one engagement mechanism (11), a tree to be felled to fix the base body (10) relative to the tree;
moving, by the drive unit (40), the pressure wedge body (20) relative to the base body (10); and
conveying lubricant (61) from the lubricant tank (60) to the pressure wedge body (20).

32. The method according to claim 31,
wherein conveying the lubricant (61) comprises conveying the lubricant (61) from the lubricant tank (60) to the pressure wedge body (20) through the drive unit (40).
